(19) United States
(12) Patent Application Publication
(10) Pub. No.: US 2016/0077375 A1
(43) Pub. Date: Mar. 17, 2016

(54) ASYMMETRICAL LUMINANCE ENHANCEMENT STRUCTURE FOR REFLECTIVE DISPLAY DEVICES

(71) Applicant: E INK CALIFORNIA, LLC, Fremont, CA (US)

(72) Inventor: Craig LIN, Oakland, CA (US)

(21) Appl. No.: 14/950,217

(22) Filed: Nov. 24, 2015

Related U.S. Application Data
(63) Continuation-in-part of application No. 12/686,197, filed on Jan. 12, 2010.
(60) Provisional application No. 61/144,322, filed on Jan. 13, 2009.

(51) Int. Cl. G02F 1/1335; G02F 1/167

(52) U.S. Cl. CPC G02F 1/133504; G02F 1/167; G02F 2001/133507

(57) ABSTRACT

The present invention is directed to a luminance enhancement structure comprising grooves and columns, wherein the grooves have a triangular cross-section and a top angle, and the triangular cross-section having two sides which are not equal. The luminance enhancement structure is useful for reflective display devices. The structure can reduce total internal reflection, thus enhancing the brightness of a display device.

This application is a continuation-in-part of U.S. application Ser. No. 12/686,197, filed Jan. 12, 2010, which claims priority to U.S. Provisional Application No. 61/144,322, filed Jan. 13, 2009; the above applications are incorporated herein by reference in their entireties.

### FIELD OF THE INVENTION

The present invention is directed to a luminance enhancement structure for reflective display devices. The structure can reduce total internal reflection, thus enhancing the brightness of a display device.

### BACKGROUND OF THE INVENTION

The lack of satisfactory brightness is often a concern for electrophoretic display devices. Total internal reflection inevitably would occur with electrophoretic display devices. This is due to the fact that an electrophoretic display device usually has components of a high refractive index. Because of the component having a higher refractive index (e.g., about 1.5) than the air (which has a refractive index of about 1) surrounding the display panel, some of the scattering light from the display device may reflect back to the display device by total internal reflection. This total internal reflection phenomenon may result in a loss of about 30-50% of the scattering light, thus causing reduction in brightness of the display device.

The Lambertian reflectance which is part of the nature of electrophoretic displays is beneficial for certain display applications. This is so because it allows viewing of a display device at all angles, with almost the same brightness. However, the Lambertian reflectance is not always an important factor for some display applications. For example, for an e-reader, the viewers would only view the e-reader display within a certain angle. In other words, the off-axis brightness of an e-reader is less important than the on-axis brightness. Therefore, it might be beneficial, in such a case, to trade the off-axis brightness for improved on-axis brightness.

### SUMMARY OF THE INVENTION

The first aspect of the present invention is directed to a luminance enhancement structure which comprises grooves and columns wherein said grooves have a triangular cross-section and a top angle, and said triangular cross-section have two sides which are not equal. In the first aspect of the invention, there are several embodiments. Among them:

In one embodiment, one of the two sides of the triangular cross-section is tilted and the other side is almost vertical to the top surface of the columns. In one embodiment, the surface of the grooves is coated with a metal layer or uncoated. In one embodiment, the top angle of the triangular cross-section is in the range of about 5° to about 50°, preferably in the range of about 15° to about 30°. In one embodiment, the space within the grooves is filled with air. In another embodiment, the space within the grooves is filled with a low refractive index material. In one embodiment, the luminance enhancement structure is formed from a material having a refractive index of about 1.4 to about 1.7.

The second aspect of the present invention is directed to a reflective display device assembly, which comprises
(a) a display panel comprising display cells and a top substrate layer on the viewing side of the display device; and
(b) a luminance enhancement structure on top of the display panel on the viewing side of the display device, which luminance enhancement structure comprises grooves and columns wherein the grooves have a triangular cross-section and a top angle, the triangular cross-section having two sides which are not equal.

In the second aspect of the invention, there are several embodiments. Among them:

In one embodiment, one of the two sides of the triangular cross-section is tilted and the other side is almost vertical to the top surface of the columns. In one embodiment, the top surface of the columns is in optical contact with the top substrate layer. In one embodiment, the top substrate layer is formed of polyethylene terephthalate. In one embodiment, the top substrate layer has a thickness in the range of about 5 μm to about 175 μm, preferably in the range of about 1 μm to about 50μ, more preferably in the range of about 1 μm to about 25 μm. In one embodiment, the top angle of the triangular cross-section is in the range of about 5° to about 50°, more preferably in the range of about 15° to about 30°. In one embodiment, the surface of the grooves is uncoated. In another embodiment, the surface of the grooves is coated with a metal layer. In one embodiment, the space within the grooves is filled with air. In another embodiment, the space within the grooves is filled with a low refractive index material. In one embodiment, the luminance enhancement structure is formed of a material having a refractive index of about 1.4 to about 1.7. In one embodiment, the ratio of the width of the top surface of a column to the distance between the luminance enhancement structure and the top of the display cells is at least about 2. In one embodiment, the display device is viewed with the columns and grooves in a horizontal direction facing the viewer and the vertical side of the triangular cross-section of the grooves facing the top side of the display device.

The luminance enhancement structure of the present invention increases the overall reflectance by reducing the total internal reflection. As a result, the brightness of a display device is increased. Moreover, while the luminance enhancement effect of the asymmetrical type of luminance enhancement structure is not as pronounced as that of the symmetrical type as disclosed in U.S. Publication No. 2009/0231245, the asymmetrical type is not sensitive to the angle of incoming light. Therefore, the asymmetrical type of enhancement structure can be used under most of lighting conditions.

Furthermore, the structure can be fabricated by a cost effective roll-to-roll manufacturing process.

### BRIEF DISCUSSION OF THE DRAWINGS

For illustration purpose, some of the features in the drawings are exaggerated. Therefore the drawings are not to scale.

FIG. 1 depicts a cross-section view of a display device.

FIG. 2a is a cross-section view of a luminance enhancement structure of the present invention.

FIG. 2b is a three-dimensional view of the luminance enhancement structure.

FIG. 3 depicts a cross-section view of the luminance enhancement structure on the viewing side of a display device.

FIG. 4 depicts an embodiment of the present invention which comprises a display device and a luminance enhancement structure on the viewing side of the display device.

FIGS. 5a-5c illustrate the dimensions of a luminance enhancement structure.

FIG. 6 illustrates the viewing of a display device with the luminance enhancement structure on its viewing surface.

FIGS. 7a-7g show an example of how the luminance enhancement structure may be fabricated.

### DETAILED DESCRIPTION OF THE INVENTION

### I. Definitions

The technical term “total internal reflection” used in this application refers to an optical phenomenon that occurs when a ray of light strikes a medium boundary at an angle larger than the critical angle with respect to the normal axis to the surface. This can only occur where light travels from a medium with a higher refractive index to one with a lower refractive index.

Generally speaking, when a ray of light crosses a boundary between materials with different refractive indices, the light will be partially refracted at the boundary surface, and partially reflected. However, if the angle of incidence is greater than the critical angle, the light will stop crossing the boundary and instead be totally reflected back.

The critical angle is calculated based on the equation of Snell's law: C=sin⁻¹(n2/n1) wherein n1 and n2 are the refractive indices of the two different media, with n1 being the higher refractive index and n2 being the lower refractive index.

### II. Display Devices

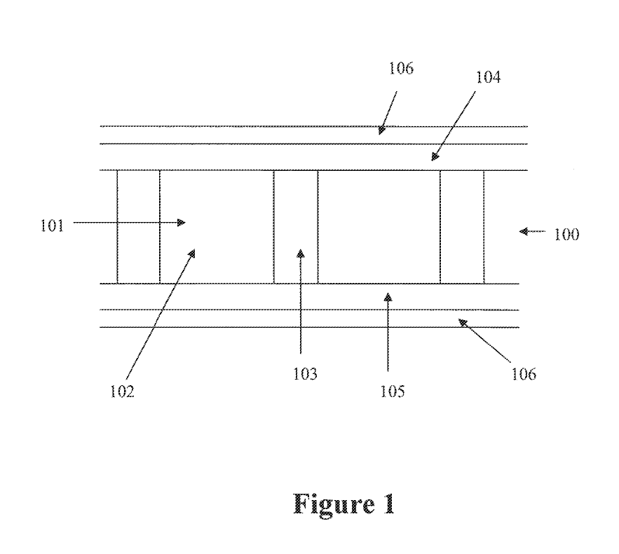

FIG. 1 illustrates a display device (100). The device comprises an array of display cells (101) filled with a display fluid (102). Each of the display cells is surrounded by partition walls (103). The array of display cells is sandwiched between two electrode layers (104 and 105).

For an electrophoretic display panel, the display cells are filled with an electrophoretic fluid which comprises charged pigment particles dispersed in a solvent. The display fluid may be a system comprising one, two or more types of charged particles.

In the system comprising only one type of particles, the charged pigment particles are dispersed in a solvent of a contrasting color. The charged particles will be drawn to one of the electrode layers (104 or 105), depending on the potential difference of the two electrode layers, thus causing the display panel to display either the color of the particles or the color of the solvent, on the viewing side.

In a system comprising two types of particles carrying opposite charges and of two contrasting colors, the particles would move to one electrode layer or the other, based on the charges that they carry and the potential difference of the two electrode layers, causing the display panel to display one of the two contrasting colors, on the viewing side. In this case, the particles may be dispersed in a clear solvent.

The display cells may also be filled with a liquid crystal composition. In addition, it is understood that the present invention is applicable to all types of reflective display devices.

For a segment display device, the two electrode layers (104 and 105) are one common electrode (e.g., ITO) and one patterned segment electrode layer, respectively. For an active matrix display device, the two electrode layers (104 and 105) are one common electrode and an array of thin film transistor pixel electrodes, respectively. For a passive matrix display device, the two electrode layers (104 and 105) are two line-patterned electrode layers. The electrode layers are usually formed on a substrate layer (106) ((such as polyethylene terephthalate (PET)). The substrate layer may also be a glass layer.

For a cup-like microcell-based display device disclosed in U.S. Pat. No. 6,930,818, the content of which is incorporated herein by reference in its entirety, the filled display cells are sealed with a polymeric sealing layer. Such a display device may be viewed from the sealing layer side or the side opposite the sealing layer side, depending on the transparency of the materials used and the application.

### III. The Luminance Enhancement Structure

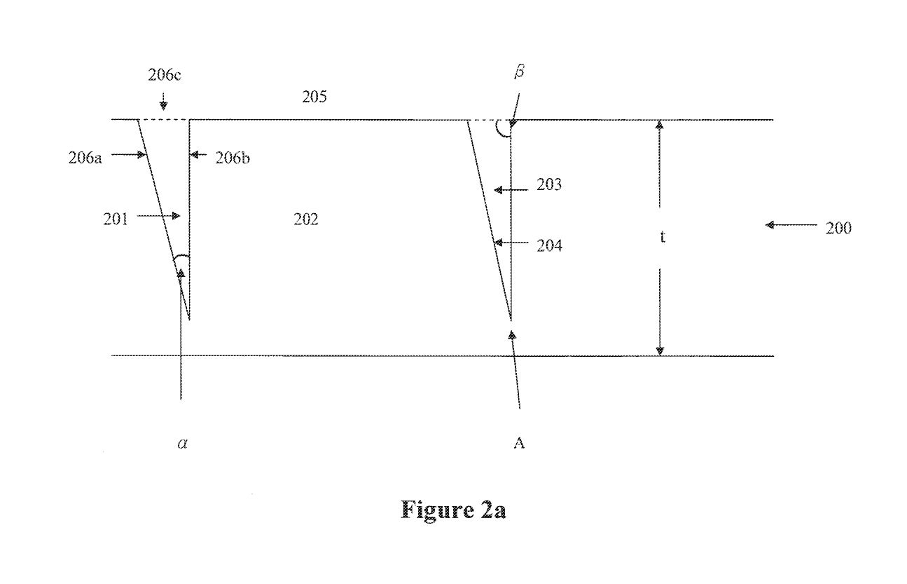

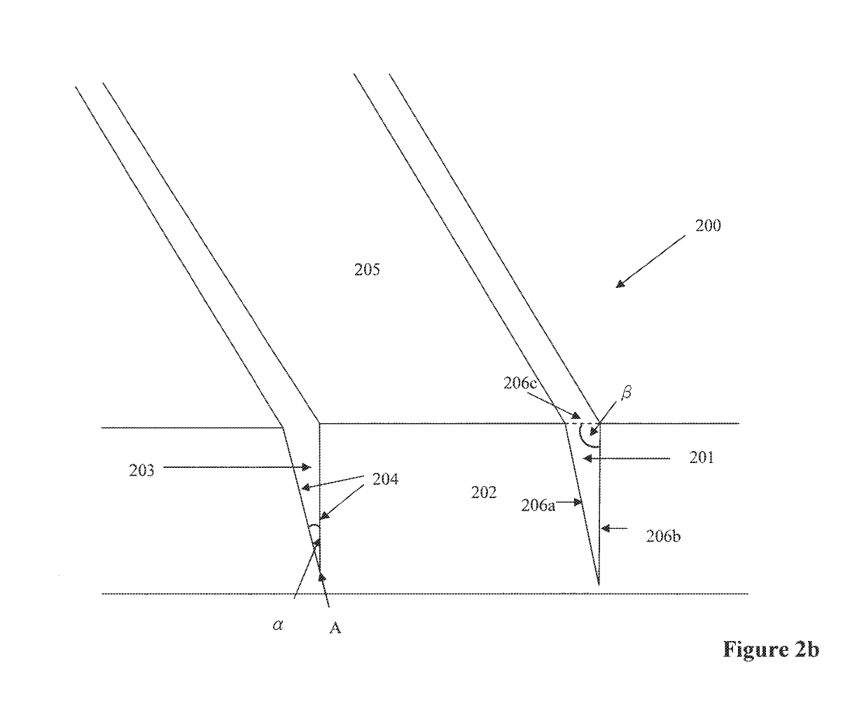

FIG. 2a is a cross-section view of a luminance enhancement structure (200) of the present invention. FIG. 2b is a three-dimensional view of the luminance enhancement structure (200). There are multiple columns (202) and grooves (203) across the structure. The groove has a triangular cross-section (201), a top angle α and a top point A. The columns (202) have a top surface (205). The grooves (203) and the column (202) are in alternating order.

The triangular cross-section of the grooves has three sides, one of which is the open side (206c). In the context of the present invention, the triangular cross-section (201) is asymmetrical. The term “asymmetrical” is intended to refer to the fact that the two non-open sides (206a and 206b) of the triangular cross-section are not equal. In one embodiment, one of the two sides is tilted (206a) and the other side (206b) is almost vertical to the top surface (205) of the column (202). Details of the dimensions of the structure are given below.

The term “almost vertical” is intended to refer to the internal angle β being in the range of about 80° to about 90°, preferably in the range of about 85° to about 90° and more preferably about 90°.

As to how tilted the side 206a is, it is determined by the angle α which is discussed in a section below.

The surface (204) of the grooves is optically flat or may be coated with a metal layer. In the context of this application, the terms “groove” or “grooves” refers to the groove or grooves the surface (204) of which is either uncoated or coated. In one embodiment of the present invention, the surface of the groove or grooves is preferably uncoated.

The thickness (t) of the luminance enhancement structure may be in the range of about 10 μm to about 200 μm, preferably about 5 μm to about 50 μm.

The luminance enhancement structure is formed from a material having a refractive index of about 1.4 to 1.7. The luminance enhancement structure is transparent.

The fabrication of such a luminance enhancement structure is illustrated in a section below.

IV. Display Device with the Luminance Enhancement Structure

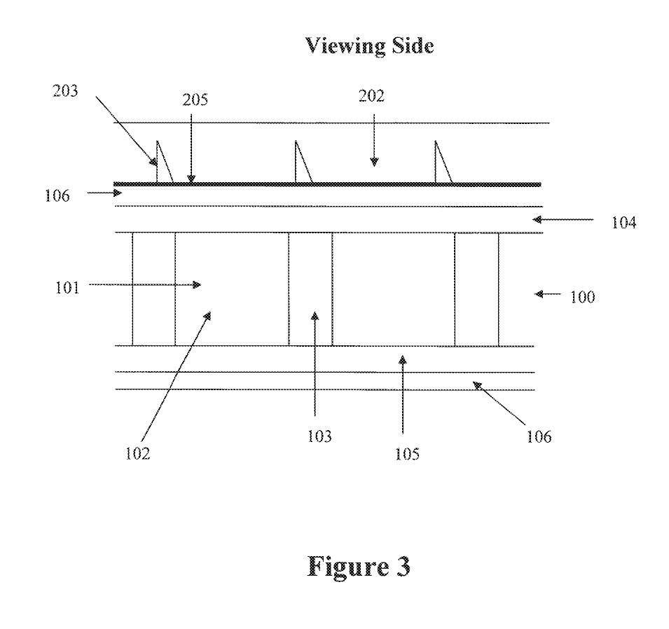

FIG. 3 depicts a cross-section view of the luminance enhancement structure on the viewing side of a display device. As shown, the luminance enhancement structure of FIG. 2a (or 2b) has been turned 180°, with the top surface (205) of the columns (202) now in optical contact with the substrate layer (106) of the display device, which means that there is no air gap between the top surface 205 and the substrate layer 106. This may be achieved by an adhesive material, such as the Norland® optical adhesive.

The space within the grooves (203) usually is filled with air. It is also possible for the space to be in a vacuum state. Alternatively, the space in the grooves (203) may be filled with a low refractive index material, lower than the refractive index of the material forming the luminance enhancement structure.

The thickness of the substrate layer (106) is usually between about 5 μm to about 175 μm, more preferably between about 1 μm to about 50 μm. In order to achieve the effect of the luminance enhancement structure, the substrate layer is preferably as thin as possible (e.g., about 1 μm to about 25μ). During formation of a display cell layer on the substrate layer, preferably the substrate layer is adhered to a base layer for mechanical strength and the display cells are formed on the side of the substrate layer.

After the display cells are formed, the base layer is removed. A luminance enhancement structure is then laminated (optionally with an adhesive layer) to the substrate layer, to complete the assembly.

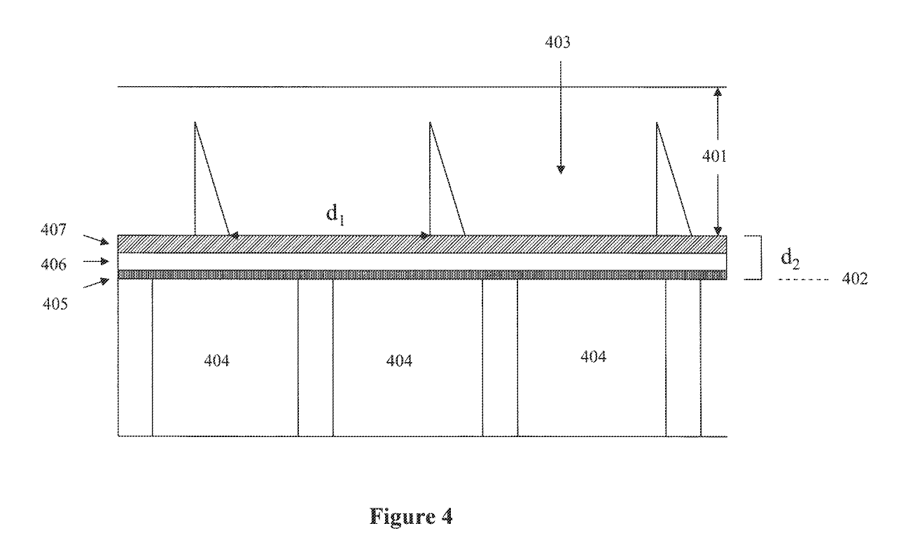

FIG. 4 shows an embodiment of the assembly comprising a display device and a luminance enhancement structure (401) on the viewing side of the display device. In this embodiment, the ratio of the width (d₁) of the top surface of the column (403) over the distance (d₂) between the luminance enhancement structure (401) and the top (402) of the display cells (404) is at least about 2. It is noted that the distance d₂ may comprise an electrode layer (405), the substrate layer (406) and optionally an adhesive layer (407).

### V. Dimensions of the Luminance Enhancement Structure

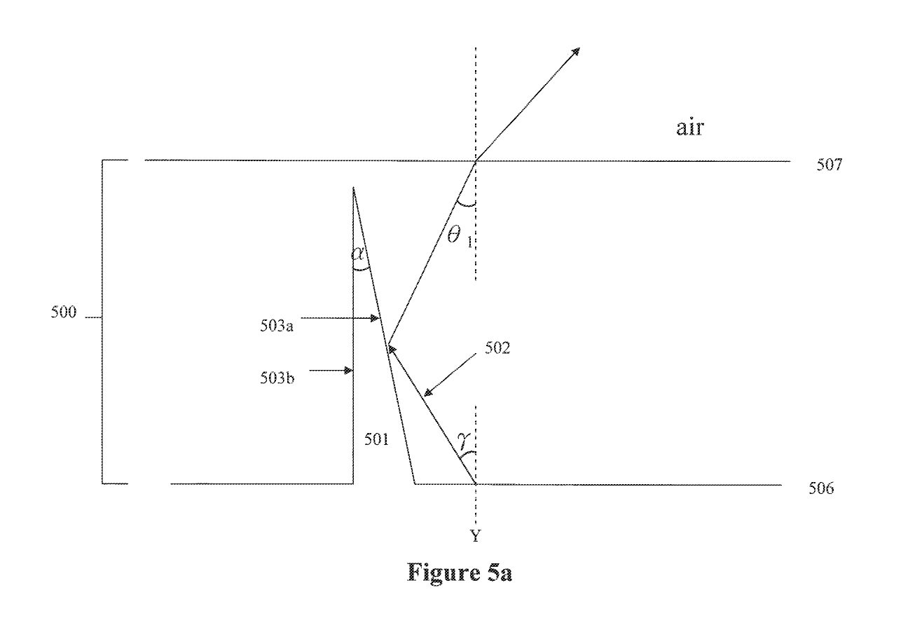

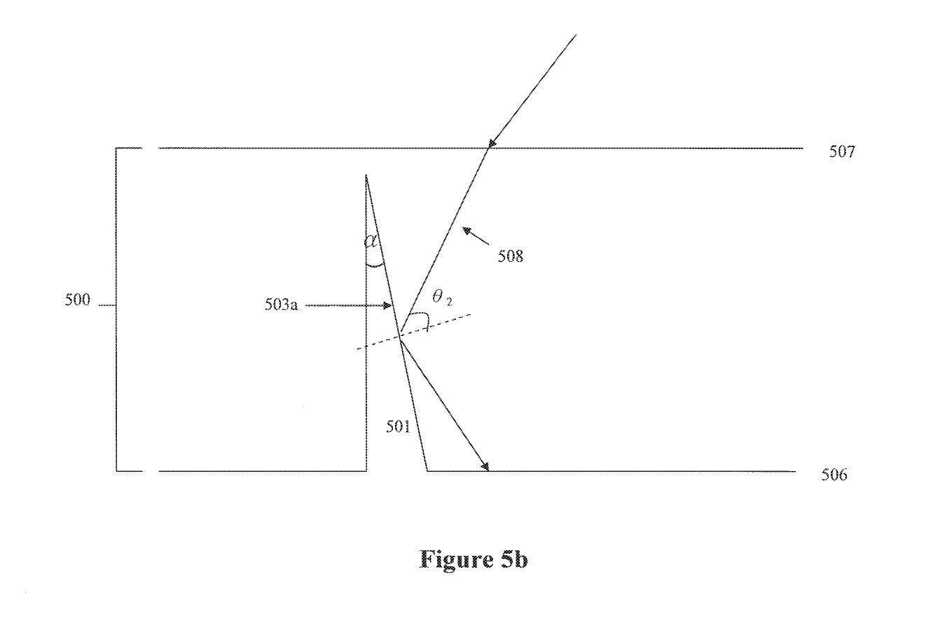

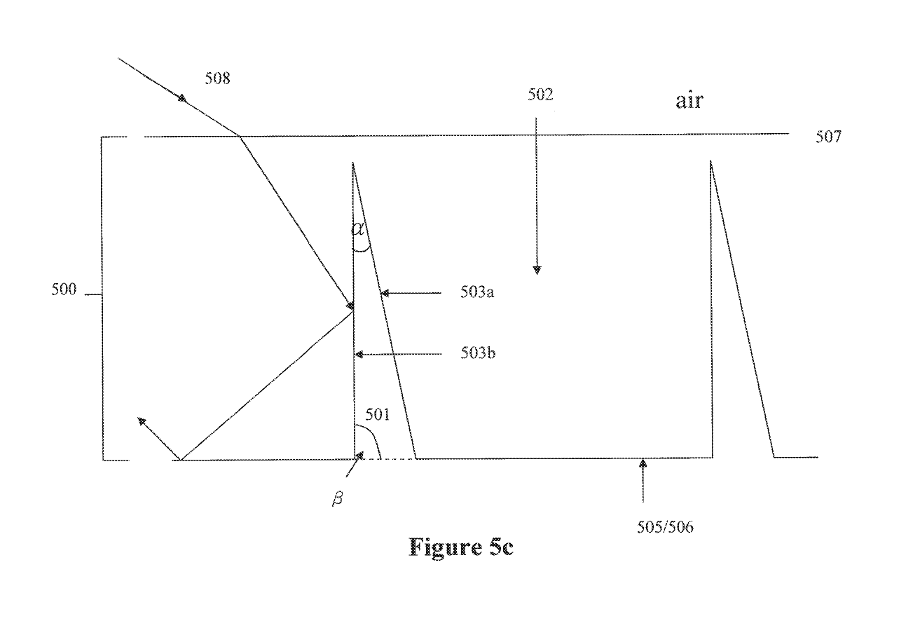

FIGS. 5a-5c illustrate the dimensions of a luminance enhancement structure of the present invention and show how the luminance enhancement structure may enhance brightness.

In FIG. 5a, it is shown that the design aims to ensure an angle of incidence θ₁ to be smaller than the critical angle C₁ (not shown) at the boundary between the top surface (507) of the luminance enhancement structure (500) and air.

The critical angle C₁, in this case, is about 42° based on the refractive index of the material for the luminance enhancement structure being 1.5 and the refractive index of air surrounding the top surface of the luminance enhancement structure being 1.

As shown in FIG. 5a, the light (502) scattered from the top surface (506) of the display device is reflected at one of the tilted surfaces (503a) of the groove (501) and reaches the top surface (507) of the luminance enhancement structure (500). In order for the angle of incidence (θ₁) at the top surface of the luminance enhancement structure to be smaller than 42°, the top angle α of the groove (501) is preferably in the range of 5 to 50°, more preferably in the range of 15 to 30°. As a result, the angle of incidence θ₁ will be smaller than the angle γ (by two times the top angle α), which reduces the chance of total internal reflection at the top surface and increases the overall optical efficiency. The angle γ is an angle at the intersection of the light (502) and the normal axis (marked Y) of the surface (506) of the display device.

An incoming light (not shown) from a light source transmits through the luminance enhancement structure and strikes the display device and is then reflected with a scattering profile. The scattered light 502 in FIG. 5a is a typical example of such a reflected light.

FIG. 5b demonstrates that one (503a) of the surfaces of the groove (501) is tilted which will reflect incoming light by total internal reflection. The design aims to ensure that the light striking the tilted surface (503a) of the groove (501) will be reflected instead of transmitting through the space within the groove. The critical angle C₂ (not shown) at the boundary between the tilted surface (503a) and the space within the groove may be calculated based on the refractive index of the material for the luminance enhancement structure and the refractive index of what is filled in the space of the groove (501). If the groove is unfilled, the refractive index of air is about 1. With the refractive index of the material for the luminance enhancement structure being about 1.5, the critical angle C₂ would be about 42°. When the angle of incidence θ₂ of the light (508) coming from the surface (507) is greater than 42°, the light striking the tilted surface (503a) will be totally internal reflected towards the boundary 506 which is desired in this case because otherwise, the light would transmit through the space in the groove.

A reflective tilted surface may be achieved by coating a metal layer over the surface of the groove. However, in one embodiment of the present invention, the surface of the grooves is preferably uncoated.

Since the light striking the tilted surface will be reflected as discussed above, the off-axis light may move toward the on-axis direction. In other words, the display device with a luminance enhancement structure of the present invention will be brighter at the on-axis angles by both reducing total internal reflection and utilizing the off-axis light.

FIG. 5c demonstrates the other surface (503b) of the groove (501) which is almost vertical to the top surface (505) of the column (502) in the luminance enhancement structure. The term “almost vertical”, as discussed above, refers to the internal angle β being in the range of about 80° to about 90°, preferably about 85° to about 90°, more preferably about 90°. The top surface (505) of the column, as stated, is in contact with the surface 506 of the display device. The presence of the vertical side 503b avoids the incoming light striking the non-desired locations. With the vertical side, instead of the incoming light passing through the structure surface, the light will strike the vertical surface (503b) of the groove and be totally internal reflected to the display surface (506).

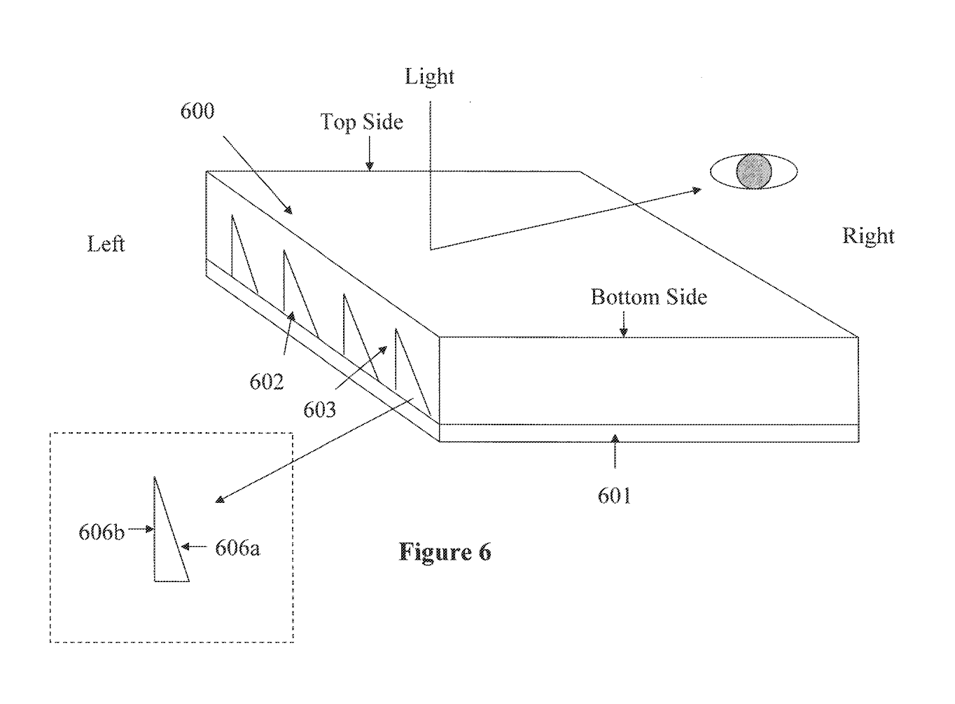

In order to fully utilize the benefits of the luminance enhancement structure of the present invention, the enhancement structure is preferably aligned horizontally facing the viewer. FIG. 6 is a simplified drawing to illustrate this feature. As shown in FIG. 6, the display device (601) with a luminance enhancement structure (600) on its viewing side is viewed in such a way that the columns (603) and grooves (602) of the luminance enhancement structure (600) are in a horizontal direction to the viewer facing the display device, with the vertical side (606b) of the grooves facing the top side of the display device and the tilted side (606a) of the grooves facing the bottom side of the display device. When the display device is viewed in such a manner, the beneficial effects of the luminance enhancement structure would not be affected by the angle of the incoming light whether the light is coming from above the display device, from the right side of the device or from the left side of the device. However, when the light is coming from the bottom side of the display device, the brightness enhancement is less effective.

The luminance enhancement structure (600) is on the viewing side of a display device.

### VI. Fabrication of the Luminance Enhancement Structure

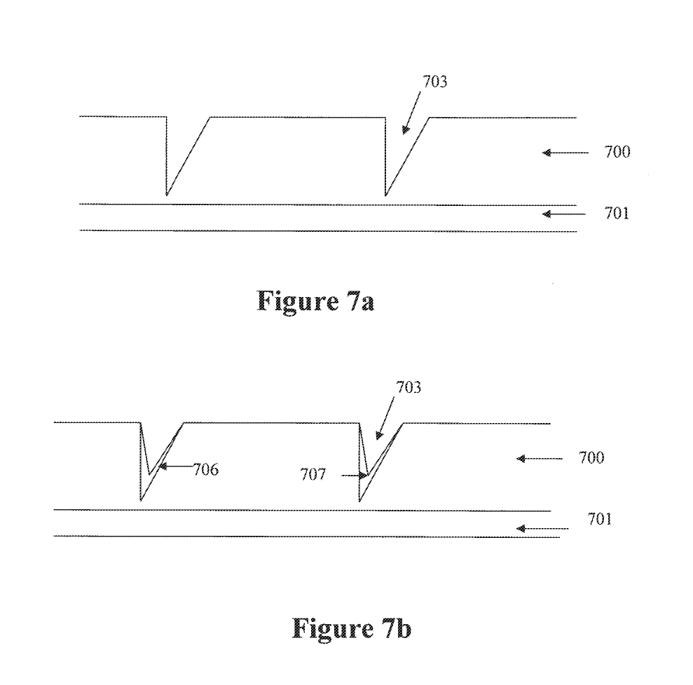

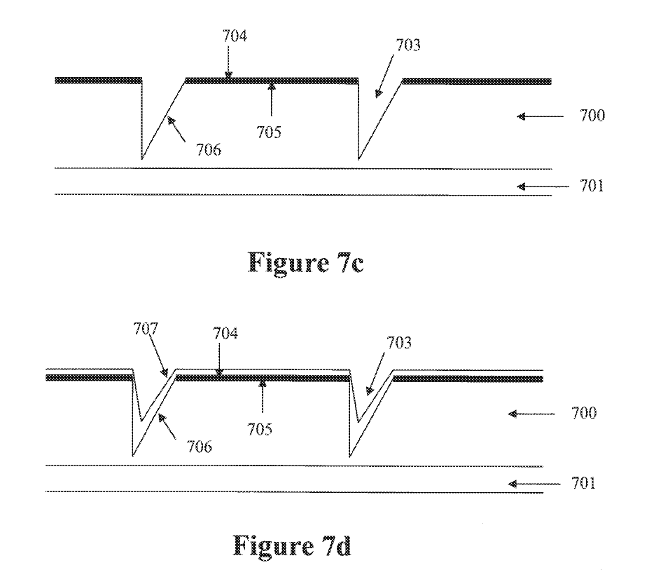

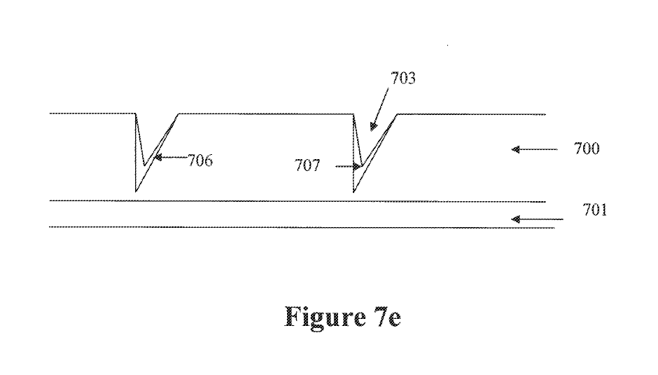

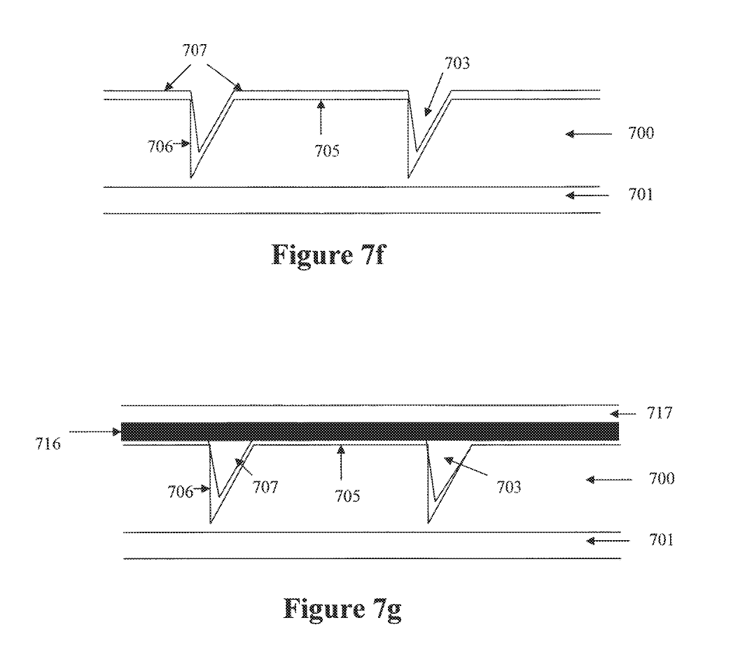

The luminance enhancement structure may be fabricated in many different ways. In one embodiment, the luminance enhancement structure may be fabricated separately and then laminated over the viewing side of the display device. For example, the luminance enhancement structure may be fabricated by embossing as shown in FIG. 7a. The embossing process is carried out at a temperature higher than the glass transition temperature of the embossable composition (700) coated on a substrate layer (701). The embossing is usually accomplished by a mold which may be in the form of a roller, plate or belt. The embossable composition may comprise a thermoplastic, thermoset or a precursor thereof. More specifically, the embossable composition may comprise multifunctional acrylate or methacrylate, multifunctional vinylether, multifunctional epoxide or an oligomer or polymer thereof. The glass transition temperatures (or Tg) for this class of materials usually range from about −70° C. to about 150° C., preferably from about −20° C. to about 50° C. The embossing process is typically carried out at a temperature higher than the Tg. A heated mold or a heated housing substrate against which the mold presses may be used to control the embossing temperature and pressure. The mold is usually formed of a metal such as nickel.

The mold is preferably manufactured by the diamond turning technique. Typically the mold is made by diamond turning technique on a cylindrical blank known as a roll. The surface of the roll is typically of hard copper, although other materials may be used. The pattern on the mold (roll) is the opposite of the intended luminance enhancement structure. In other words, the roll will show sharp protruding patterns which are corresponding to the grooves of the luminance enhancement structure. The pattern on the roll is formed in a continuous manner around the circumference of the roll. In a preferred embodiment, the indentations on the surface of the roll are produced by a technique known as thread cutting. In thread cutting, a single, continuous indentation is cut on the roll while the diamond cutter is moved in a direction transverse to the turning roll. If the mold to be produced has a constant pitch, during manufacture of the mold, the roll will move at a constant velocity. A typical diamond turning machine will provide independent control of the depth that the cutter penetrates the roll, the horizontal and vertical angles that the cutter makes to the roll and the transverse velocity of the cutter.

As shown in FIG. 7a, the mold creates the grooves (703) and is released during or after the embossable composition is hardened.

The hardening of the embossable composition may be accomplished by cooling, solvent evaporation, cross-linking by radiation, heat or moisture.

The refraction index of the material for forming the luminance enhancement structure is preferably greater than about 1.4, more preferably between about 1.5 and about 1.7.

The luminance enhancement structure may be used as is, or further coated with a metal layer.

The metal layer (707) is then deposited over the surface (706) of the grooves (703) as shown in FIG. 7b. Suitable metals for this step may include, but are not limited to, aluminum, copper, zinc, tin, molybdenum, nickel, chromium, silver, gold, iron, indium, thallium, titanium, tantalum, tungsten, rhodium, palladium, platinum and cobalt. Aluminum is usually preferred. The metal material must be reflective, and it may be deposited on the surface (706) of the grooves, using a variety of techniques such as sputtering, evaporation, roll transfer coating, electroless plating or the like.

In order to facilitate formation of the metal layer only on the intended surface (i.e., the surface 706 of the grooves), a strippable masking layer may be coated before metal deposition, over the surface on which the metal layer is not to be deposited. As shown in FIG. 7c, a strippable masking layer (704) is coated onto the surface (705) between the openings of the grooves. The strippable masking layer is not coated on the surface (706) of the grooves.

The coating of the strippable masking layer may be accomplished by a printing technique, such as flexographic printing, driographic printing, electrophotographic printing, lithographic printing, gravure printing, thermal printing, inkjet printing or screen printing. The coating may also be accomplished by a transfer-coating technique involving the use of a release layer. The strippable masking layer preferably has a thickness in the range of about 0.01 to about 20 microns, more preferably about 1 to about 10 microns.

For ease of stripping, the layer is preferably formed from a water-soluble or water-dispersible material. Organic materials may also be used. For example, the strippable masking layer may be formed from a re-dispersible particulate material. The advantage of the re-dispersible particulate material is that the coated layer may be easily removed without using a solubility enhancer. The term “re-dispersible particulate” is derived from the observation that the presence of particles in the material in a significant quantity will not decrease the stripping ability of a dried coating and, on the contrary, their presence actually enhances the stripping speed of the coated layer.

The re-dispersible particulate consists of particles that are surface treated to be hydrophilic through anionic, cationic or non-ionic functionalities. Their sizes are in microns, preferably in the range of about 0.1 to about 15 um and more preferably in the range of about 0.3 to about 8 um. Particles in these size ranges have been found to create proper surface roughness on a coated layer having a thickness of <15 um. The re-dispersible particulate may have a surface area in the range of about 50 to about 500 m²/g, preferably in the range of about 200 to about 400 m²/g. The interior of the re-dispersible particulate may also be modified to have a pore volume in the range of about 0.3 to about 3.0 ml/g, preferably in the range of about 0.7 to about 2.0 ml/g.

Commercially available re-dispersible particulates may include, but are not limited to, micronized silica particles, such as those of the Sylojet series or Syloid series from Grace Davison, Columbia, Md., USA.

Non-porous nano sized water re-dispersible colloid silica particles, such as LUDOX AM can also be used together with the micron sized particles to enhance both the surface hardness and stripping rate of the coated layer.

Other organic and inorganic particles, with sufficient hydrophilicity through surface treatment, may also be suitable. The surface modification can be achieved by inorganic and organic surface modification. The surface treatment provides the dispensability of the particles in water and the re-wettability in the coated layer.

In FIG. 7d, a metal layer (707) is shown to be deposited over the entire surface, including the surface (706) of the grooves and the surface (705) between the grooves. Suitable metal materials are those as described above. The metal material must be reflective and may be deposited by a variety of techniques previously described.

FIG. 7e shows the structure after removal of the strippable masking layer (704) with the metal layer 707 coated thereon. This step may be carried out with an aqueous or non-aqueous solvent such as water, MEK, acetone, ethanol or isopropanol or the like, depending on the material used for the strippable masking layer. The strippable masking layer may also be removed by mechanical means, such as brushing, using a spray nozzle or peeling it off with an adhesive layer. While removing the strippable masking layer (704), the metal layer (707) deposited on the strippable masking layer is also removed, leaving the metal layer (707) only on the surface (706) of the grooves.

FIGS. 7f and 7g depict an alternative process for depositing the metal layer. In FIG. 7f, a metal layer (707) is deposited over the entire surface first, including both the surface (706) of the grooves and the surface (705) between the grooves. FIG. 7g shows that the film of grooves deposited with a metal layer (707) is laminated with a film (717) coated with an adhesive layer (716). The metal layer (707) on top of the surface (705) may be conveniently peeled off when the film of grooves is delaminated (separated) from the adhesive layer (716) coated film (717). The thickness of the adhesive layer (716) on the adhesive coated film is preferably in the range of about 1 to about 50 um and more preferably in the range of about 2 to about 10 um.

The luminance enhancement structure comprising grooves (uncoated or coated with a metal layer) is then laminated over a layer of display cells as described above. While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A reflective display device assembly, comprising:
(a) a display device comprising display cells and a top substrate layer on the viewing side of the display device; and
(b) a luminance enhancement structure on the viewing side of the display device, wherein said structure comprises grooves and columns in an alternating order, and
(i) each of said grooves has a triangular cross-section and a top angle, and said triangular cross-section has two sides which are not equal and one of the two sides is a tilted side and the other side is a vertical side, and
(ii) each of said columns has a top surface separating the grooves wherein the top surface connects the end point of the tilted side of a groove to the end point of the vertical side of a neighboring groove and the vertical side is almost vertical to the top surface of the column, and the top surfaces of the columns are in optical contact with the top substrate layer of the display device.

2. The assembly of claim 1, wherein the top angle is in the range of about 5° to about 50°.

3. The assembly of claim 1, wherein the top substrate layer has a thickness in a range of about 5 μm to about 175 μm.

4. The assembly of claim 1, wherein the surface of each of the grooves is uncoated.

5. The assembly of claim 1, wherein the surface of each of the grooves is coated with a metal layer.

6. The assembly of claim 1, wherein the space within each of the grooves is filled with air.

7. The assembly of claim 1, wherein the space within each of the grooves is filled with a low refractive index material.

8. The assembly of claim 1, wherein said luminance enhancement structure is formed of a material having a refractive index of about 1.4 to about 1.7.

9. The assembly of claim 1, wherein the display device has a top side and a bottom side and the columns and grooves are in a horizontal direction with the vertical side of the triangular cross-section of the grooves facing the top side of the display device.

10. The assembly of claim 1, wherein the vertical side and the top surface of the column form an internal angle of about 90°.

11. A method for enhancing luminance of a display device, comprising:
(a) using a reflective display device assembly of claim 1; and
(b) viewing the display device through the luminance enhancement structure, wherein the columns and grooves are in a horizontal direction facing a viewer with the vertical side of the triangular cross-section of the grooves facing a top side of the display device.

12. The method of claim 11, wherein the top angle is in the range of about 5° to about 50°.

13. The method of claim 11, wherein the top substrate layer has a thickness in a range of about 5 μm to about 175 μm.

14. The method of claim 11, wherein the surface of each of the grooves is uncoated.

15. The method of claim 11, wherein the surface of each of the grooves is coated with a metal layer.

16. The method of claim 11, wherein the space within each of the grooves is filled with air.

17. The method of claim 11, wherein the space within each of the grooves is filled with a low refractive index material.

18. The method of claim 11, wherein said luminance enhancement structure is formed of a material having a refractive index of about 1.4 to about 1.7.
